(19) United States
(12) Patent Application Publication
(10) Pub. No.: US 2008/0192130 A1
(43) Pub. Date: Aug. 14, 2008

(54) Method And Apparatus For Compensating Black Level By Dark Current Of Image Sensor

(75) Inventor: Yo-Hwan Noh, Gyeonggi-do (KR)

Correspondence Address: HUSCH BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/911,007

(22) PCT Filed: Nov. 16, 2005
(86) PCT No.: PCT/KR2005/003868

§ 371 Date: Oct. 9, 2007

(30) Foreign Application Priority Data
Mar. 28, 2000 (JP) 2000092967
Mar. 28, 2000 (JP) 2000092971
Apr. 26, 2005 (KR) 10-2005-0034349

(51) Int. Cl. H04N 9/64

(52) U.S. Cl. 348/243; 348/E09.037

(57) ABSTRACT

The present invention is directed to a method and an apparatus for compensating for a black level of an image sensor. The apparatus for compensating for a black level comprises: an optical black area detecting unit, detecting a pixel located in an optical black area, the pixel being among a digital image signal received from the sensor unit; a pixel data analyzing unit, summing pixel data of the pixel detected by the optical black area detecting unit to a pixel data sum; and a compensated data generating unit, generating compensated pixel data corresponding to the pixel data through a matching graph generated using a normalized value. With the present invention, the black level caused by a dark current can be compensated, and the noise caused by a dark current can be removed, while maintaining the dynamic range.

### TECHNICAL FIELD

The present invention relates to a method and an apparatus for compensating for black level of an image sensor, more particularly to a method and an apparatus for compensating for black level by dark current and maintaining dynamic range.

### BACKGROUND ART

An image sensor is a device for playing an image using a property of a semiconductor reacting to light. An image sensor consists of an array of small photo diodes, called pixels, which detects brightness and a wavelength of each different light radiated from each subject, reads as an electrical value and makes this to a level that is capable of signal processing. In other words, an image sensor is a semiconductor device transforming an optical image to an electrical signal, and portable devices (for example, digital cameras and mobile communication terminals) having an image sensor have been developed and are being sold.

The image sensor generates a fixed pattern noise by an offset voltage caused by a minute difference in production process. To compensate this, the image sensor uses the CDS (correlated double sampling) method, by which a reset signal and a data signal are read from each pixel of a pixel array before outputting the difference.

Although the image sensor operates at temperatures of 0° C. to 40° C., it must operate at temperatures of over 60° C. without changing its properties while being transported or under a special environment. However, the image sensor consists of semiconductor elements and thus generates an electric current caused by the heat at a high temperature. This is called a dark current, and if the dark current is generated, the image sensor has other electrical signal properties as well as electrical signal properties caused by optical factors. Therefore, a noise, in which a certain level of signal is detected although no light is applied, is generated, and this noise is called a black level.

The black level has a property of shifting up signal components as the temperature increases. The conventional method for preventing the decrease in property by this black level is as follows. FIG. 1 is a diagram showing an optical black area for obtaining an offset value, and FIG. 2 is a diagram illustrating a method for compensating for the black level according to the conventional art.

Referring to FIG. 1, an image sensor comprises a core pixel array 100 to detect information of an image inputted from outside, a first optical black area 110 and a second optical black area 120 being arranged on one side of the column direction and one side of the row direction of the core pixel array 100 and for calculating an offset value of a black level on constitute pixels. Apart 130 shown by enlarging the second optical black area 120 shows that each of the pixels dose not have a consistent value but a different value depending on the magnitude of a signal. A normalized value of the signal magnitudes of the first optical black area 110 and the second optical black area 120 is obtained, and this normalized value is determined to be a compensating value of the black level, that is, a black level offset value 220. And the black level offset value 220 is subtracted from the entire image data.

In FIG. 2, the size of an image data is 10 bits, and thus can express a signal in an overall magnitude of 0 to 1023. In this case, it is preferable that an input signal of an actual image data match with an output signal and that the actual image data is expressed like an ideal graph 210, without any black level. However, the graph between an input signal and an output signal is expressed like a compensation graph 230, the black level offset value 220 is subtracted in order to compensate the black level by the dark current. That is, the output signal has loss 240 in a dynamic range (a range that expresses an image) because the output signal reflects the black level offset value 220 subtracted from the input signal.

Moreover, one of the phenomena by the dark current is a dark current noise. A dark current noise is a phenomenon shown because the property of each pixel cell, which is the smallest unit of an image sensor, is different from each other as illustrated in the part enlarging the second optical black area 120 of FIG. 1. Because of this, although a clean plane is shown, it does not show a uniform and clean image but shows an image having a sizzling noise. There is a problem that this noise cannot be reduced by the conventional subtraction method.

### DISCLOSURE

[Technical Problem]

Therefore, an object of the present invention in order to solve the problems described above is the provision of a method and an apparatus for compensating for black level that can compensate for the phenomenon of image separation by a dark current.

Another object of the present invention is the provision of a method and an apparatus for compensating for black level to enlarge the rendering range of image data and show a clearer and more vivid image by maximizing the dynamic range of the image.

Another object of the present invention is the provision of a method and an apparatus for compensating for black level to show a clearer image by clamping the dark current noise generated by a dark current.

[Technical Solution]

In order to achieve the above objects, an aspect of the present invention features a method for compensating for a black level of an image sensor. The method comprises: (a) initializing a frame and receiving a digital image signal; (b) analyzing pixel information of a pixel included in the frame, wherein the digital image signal comprises the pixel information, and the pixel information comprises pixel data and area information of an area in which the pixel is located; (c) generating a pixel data sum by summing the pixel data of the pixel located in an optical black area; (d) calculating a normalized value using the pixel data sum; (e) generating a matching graph drawn from the normalized value; and (f) generating a compensated pixel data through the matching graph, the compensated pixel data corresponding to the pixel data. The compensated pixel data generated by the matching graph has no loss of dynamic range.

Preferably, the pixel data has n bits, whereas n is a natural number, and the value of the pixel data is between 0 and 2ⁿ-1. In case the dynamic range of the compensated pixel data has a value between 0 and 2ⁿ-1, the matching graph takes the pixel data for an independent variable and the compensated pixel data for a dependent variable, and comprises a line, in which the compensated pixel data is 0 in the range where the pixel data is between 0 and the normalized value, and another line drawn by a linear equation, which connects the normalized value and 2ⁿ-1 in the range where the pixel data is between the normalized value and 2ⁿ-1, whereby the compensated pixel data is 2ⁿ-1 when the pixel data is 2ⁿ-1.

Moreover, the normalized value is obtained by dividing the pixel data sum with the total number of pixels included in the optical black area. After the step (e) and before the step (f), the method further comprises: (e-1) converting each value of clamp bits among bits of the pixel data to a predetermined value of 0 or 1, wherein, in case the pixel data is comprised of a bit stream of n (natural number) digits expressed in binary number, the clamp bits are a bit stream of sequential digits having a predetermined size comprising a least significant bit among the bits of n digits of the pixel data. Or, after the step (e) and before the step (f), the method further comprises: (e-1) calculating a maximum value and a minimum value among the pixel data of the pixel included in the optical black area; (e-2) setting bits corresponding to a difference between the maximum value and the minimum value as clamp bits among the bits of the pixel data; and (e-3) converting a value of the clamp bits to a predetermined value of 0 or 1.

In order to achieve the above objects, another aspect of the present invention features an apparatus for compensating for black level. The apparatus comprises: an optical black area detecting unit, detecting a pixel located in an optical black area, the pixel being among a digital image signal received from the sensor unit; a pixel data analyzing unit, summing pixel data of the pixel detected by the optical black area detecting unit to a pixel data sum; and a compensated data generating unit, generating compensated pixel data corresponding to the pixel data through a matching graph generated using a normalized value. The normalized value is obtained by dividing the pixel data sum with the total number of pixels included in the optical black area, and the compensated pixel data has no loss of dynamic range and is outputted through the image data output unit.

Preferably, the apparatus further comprises a digital clamping performing unit, converting each value of clamp bits among bits of the pixel data to a predetermined value of 0 or 1. In case the pixel data is comprised of a bit stream of n (natural number) digits expressed in binary number, the clamp bits are a bit stream of sequential digits having a predetermined size comprising a least significant bit among the bits of n digits of the pixel data. The clamp bits correspond to a difference between a maximum value and a minimum value of the pixel data of the pixel included in the optical black area.

Additional aspects and advantages of the present general inventive concept will be set forth in part in the description which follows and, in part, will be obvious from the description, or may be learned by practice of the general inventive concept.

### DESCRIPTION OF DRAWINGS

FIG. 1 is a diagram showing an optical black area for obtaining an offset value;

FIG. 2 is a diagram illustrating a method for compensating for the black level according to the conventional art;

FIG. 3 is a diagram outlining the structure of an apparatus for compensating for black level according to a preferred embodiment of the present invention;

FIG. 4 is a flowchart of a method for compensating for black level and removing noise according to a preferred embodiment of the present invention;

FIG. 5 is a graph showing pixel data of pixels included in an optical black area;

FIG. 6 is a diagram outlining the structure of clamp bits according to a preferred embodiment of the present invention;

FIG. 7 is a diagram illustrating the effect of digital clamping performing unit according to a preferred embodiment of the present invention;

FIG. 8 is a diagram detailing the effect of digital clamping performing unit according to a preferred embodiment of the present invention; and

FIG. 9 is a matching graph according to a preferred embodiment of the present invention.

### MODE FOR INVENTION

Hereinafter, preferred embodiments of a method and an apparatus for compensating for black level caused by a dark current according to the invention will be described in more detail with reference to the accompanying drawings. In the description with reference to the accompanying drawings, the components that are the same or are in correspondence are assigned the same reference number regardless of the figure number, and redundant explanations are omitted. Also, the basic principles will be described first before discussing the preferred embodiments of the invention.

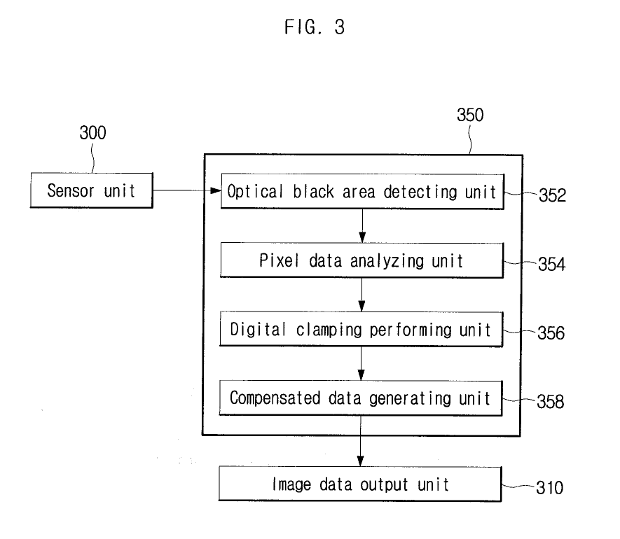

FIG. 3 is a diagram outlining the structure of an apparatus for compensating for black level according to a preferred embodiment of the present invention. The black level compensating apparatus 350 receives image data from a sensor unit 300 and outputs corrected image data, generated by compensating for black level of the image data, through an image data output unit 310. The black level compensating apparatus 350 comprises an optical black area detecting unit 352, a pixel data analyzing unit 354 and a compensated data generating unit 358. The black level compensating apparatus 350 can further comprise a digital clamping performing unit 356 in order to remove noise by a dark current. It is preferred that the black level compensating unit 350 compensates for the black level frame by frame.

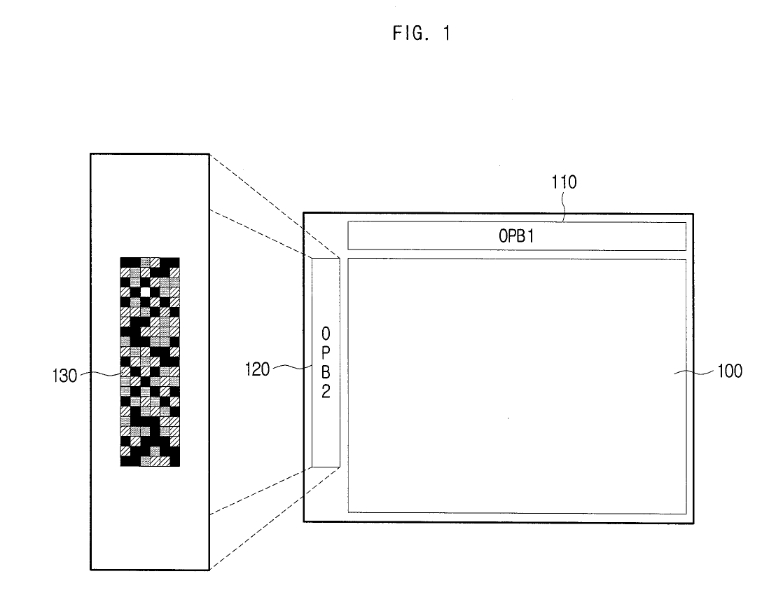

The image data, that is, a digital image signal, received from the sensor unit 300, comprises data of pixels located in the core pixel array 100, the first optical black area 110 and the second black area 120 shown in FIG. 1. The optical black area detecting unit 352 separately detects data of pixels located only in the first optical black area 110 and the second black area 120 of the image data. For black level compensation, data of an area which is absolutely irrelevant to the optical image is needed, and the data of the first optical black area 110 and the second optical black area 120 qualify for this data. In general, most sensors have the optical black area, which has a light-blocking filter instead of a color filter. Therefore, it is possible to know only pure cell properties of the pixel cell of the image sensor.

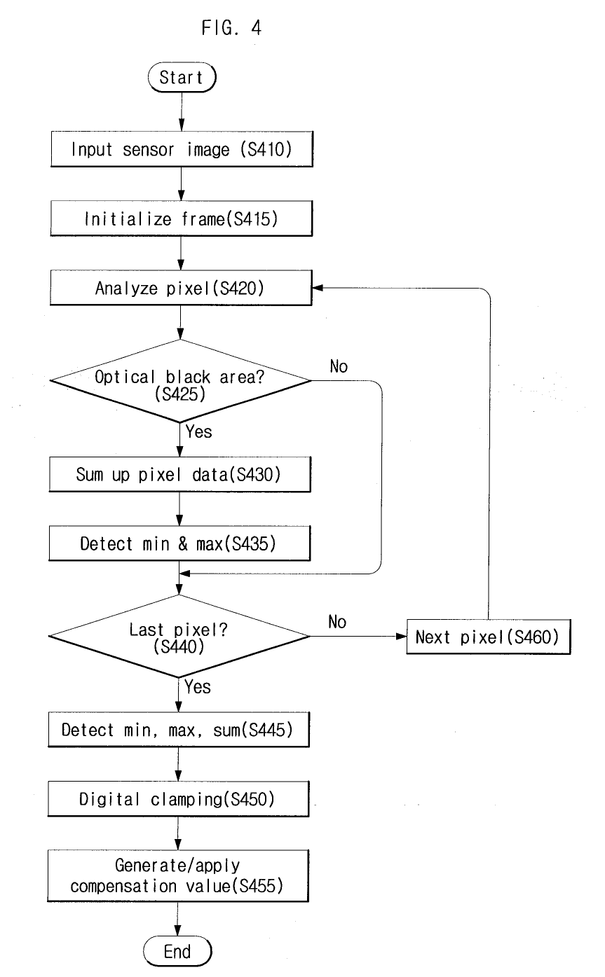

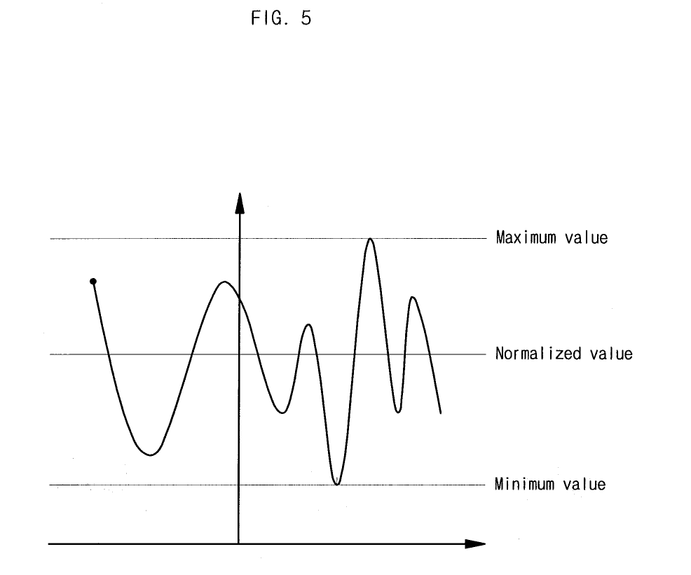

The pixel data analyzing unit 354 analyzes the data of the pixels detected by the optical black area detecting unit 352. The pixel data analyzing unit 354 includes a pixel data sum module (not shown) for calculating a normalized value of the data of pixels located in the first optical black area 110 and the second optical black area 120. And the pixel data analyzing unit 354 may further comprise a maximum and minimum data detection module (not shown) for checking a dark current noise irregularly shown by the dark current. The function and role of each module are described later with reference to FIGS. 4 and 5.

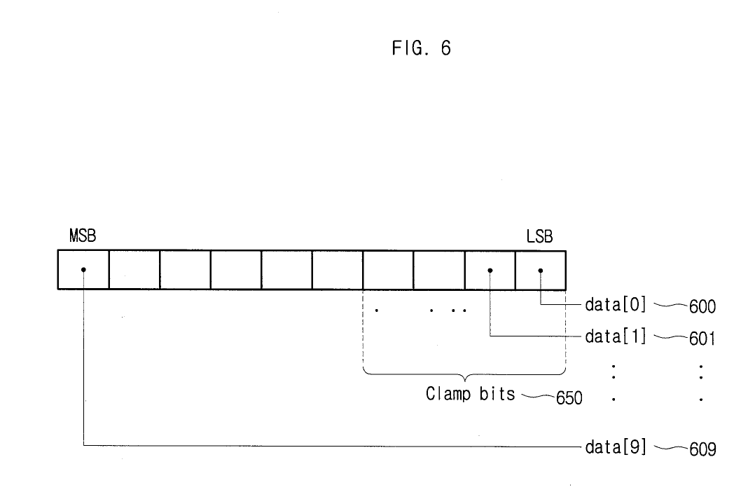

The digital clamping performing unit 356 is disposed to remove the dark current noise caused by the dark current. The pixel data value of the pixels in the area detected by the optical black area detecting unit 352 oscillates irregularly. It has a role of stabilizing the pixel data value by removing some value from the normalized value level. The function and role of the digital clamping performing unit 356 are described later with reference to FIGS. 6-8.

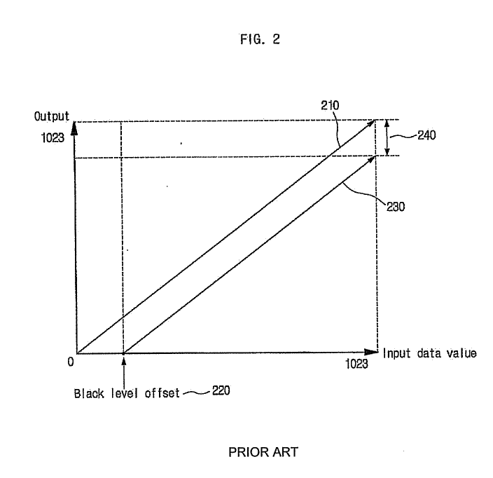

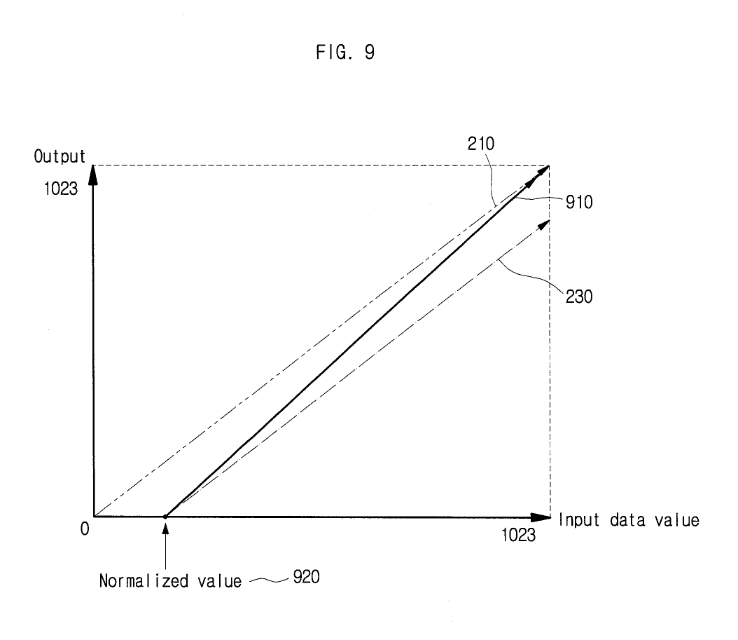

The compensated data generating unit 358 generates a new matching graph about an input signal and an output signal based on the data analyzed by the pixel data analyzing unit 354. It is preferred that the output signal matches with the input signal, as described with reference to FIG. 2. However, since this is impossible due to the black level, the output signal is determined by generating a new matching graph according to the input signal, not by simply subtracting the black level offset value 220 as in the conventional art. Hereinafter, this will be described in detail with reference to FIG. 4 and FIG. 9.

FIG. 4 is a flowchart of a method for compensating for black level according to a preferred embodiment of the present invention.

Referring to FIG. 4, in step S410, the black level compensating apparatus 350 receives the image data of the sensor image inputted through the sensor unit 300. The image data, which is a digital image signal, comprises the location information showing the area in which the pixel of the image data is located. Through this, it is possible whether the image data is included in the first optical black area 110 or the second optical black area 120 (hereinafter, collectively referred to as “optical black area”). The optical black area may be located as shown in FIG. 1, or on top and bottom sides or left and right sides of the core pixel array 100.

In step S415, the frame is initialized. That is, the pixel data sum, maximum value and minimum value for black level compensation are initialized. Since black level compensating and noise removal are performed one frame at a time, the compensation is performed with a different compensation value for each frame. Therefore, it is needed to initialize the pixel data sum, maximum value and minimum value for each frame.

In step S420, the area, in which the image data received line by line through the sensor unit 300 is located, is analyzed. The analysis can be performed line by line, on the entire frames or by sampling in the center line.

In step S425, it is determined whether the pixel is included in the optical black area. If the pixel is determined to be not included in the optical black area, step S440 is performed. If the pixel is determined to be comprised in the optical black area, however, the value of the pertinent pixel data is added, in step S430, to the pixel data sum accumulated so far. After summing up is completed on the entire frame, the normalize value in the optical black area can be obtained by dividing the sum with the total number of the pixels in the optical black area. This normalized value is the black level offset value 220. And in step S435, the maximum value and minimum value of the pixel data, analyzed hitherto, on pixels located in the optical black area are compared with the present pixel data, and the maximum value and minimum value are renewed if necessary.

The graph shown in FIG. 5 shows the pixel data of the pixels included in the optical black area. Each of the pixel data has a specific range of values, in which the minimum value and maximum value are detected. For the detection method, the maximum value and the minimum value can be found under the condition of knowing the information about the entire pixels of the pertinent frame, or the maximum value and the minimum value can be renewed every time the pixel data on each pixel is analyzed. Of course, it is evident that other various methods are possible to detect the maximum value and minimum value.

The pixel data sum module continuously accumulates and adds up the data of the pixels corresponding to the optical black area. After the pixel data of the last pixel of the frame is checked, the normalized value is calculated by dividing the sum by the number of pixels corresponding to the optical black area. In general, this normalized value becomes the black level offset value 220. The maximum and minimum data detection module saves the hitherto maximum value and minimum value by continuously comparing the data of the pixels corresponding to the optical black area. After the pixel data of the last pixel of the frame is checked, the maximum value and minimum value are detected among the pixel data in the optical black area.

In steps S440 and S460, it is determined whether the present pixel is the last pixel of the frame, and if the present pixel is not the last pixel, steps S420 to S435 are performed repeatedly. If the present pixel is determined to be the last pixel in step S440, the maximum value, minimum value and sum of the pixel data included in the optical black area of the frame are checked in step S445. Referring to FIG. 5, the normalized value exists between the maximum value and the minimum value. As described above, the normalized value may be calculated by dividing the summation of all values of the pixel data included in the optical black area with the number of pixels included in the optical black area. Since the normalized value is used when the compensation value is generated in the following step S455, the normalized value may be calculated in step S455.

In step S450, the digital clamping performing unit 356 removes the noise caused by a dark current, using the maximum value, the minimum value and the summation (or the normalized value). The function of the digital clamping performing unit 356 will be described below in detail with reference to FIGS. 6-8.

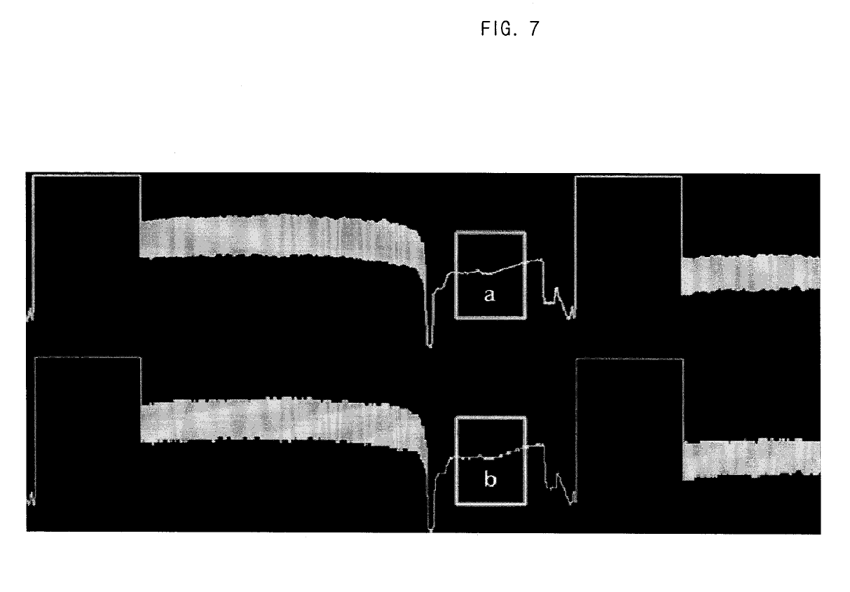

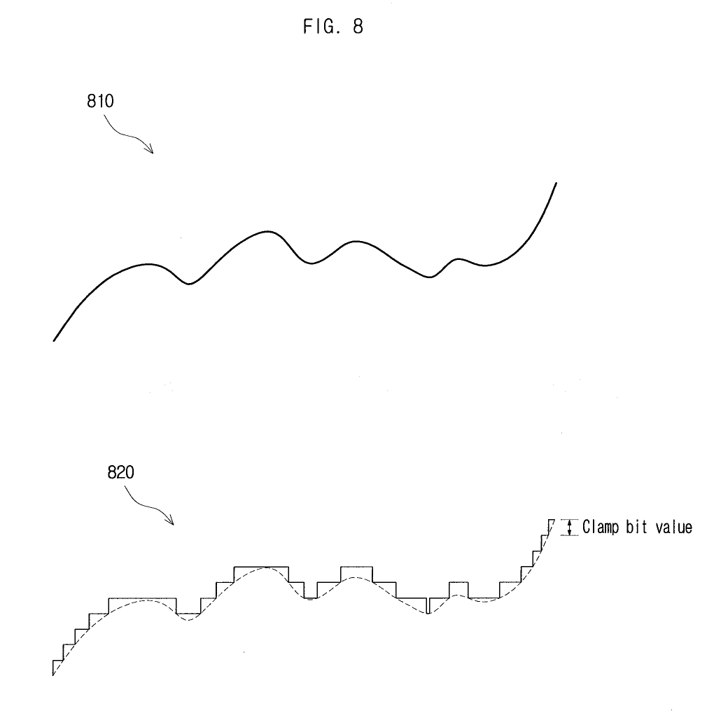

FIG. 6 is a diagram outlining the structure of clamp bits according to a preferred embodiment of the present invention. FIG. 7 illustrates the effect of the digital clamping performing unit 356 according to a preferred embodiment of the present invention. FIG. 8 is a diagram detailing the effect of the digital clamping performing unit 356 according to a preferred embodiment of the present invention.

Referring to FIG. 6, the pixel data has a size of 10 bits. This is only one embodiment, and the pixel data may have another number of bits, for example, 8 bits. The MSB (most significant bit) refers to the biggest digit in the binary number expressed in bit, and the LSB (least significant bit) refers to the smallest digit in the binary number. Assuming that the LSB is data [0] 600 and the MSB is data [9] 609, the bits located in between refer to, in sequence, bits of data [1] through data [8]. Each bit has the value of 0 or 1, and the pixel data may have the value of 0 to 1023 because there are 10 bits in the pixel data.

The pixel data having the value as shown in FIG. 5 have values between the maximum value and the minimum value based on the normalized value. With respect to the normalized value, the bits near the LSB out of the 10 bits indicating the pixel data only change. In other words, the error is generated by changing the bits of data [0] to data [n], whereby n is a natural number of 9 or smaller, and n may be a different value for each frame or the same value for every frame. Therefore, some of the irregular change or the error, forming the noise, may be offset by making the value of bits of data [0] to data [n] uniform. Here, the bits of data [0] to data [n] are clamp bits 650. If the values of the clamp bits 650 are transformed en bloc to a predetermined value of 0 or 1, the noise caused by the dark current becomes substantially removed. Through this process, the overall image data may be made even.

However, the staircase phenomenon may occur in the image if the clamping by the above processes is excessive. In order to prevent this, it is preferable to determine the size of the clamp bits 650 using the maximum value and the minimum value of the optical black area. The size of the clamp bits 650 may be different according to each frame. For example, the bits corresponding to half of the difference between the maximum value and the minimum value can be determined to be the clamp bits 650. If the difference between the maximum value and the minimum value is 8, half of the difference is 4, that is, 100 in binary digit, and thus, it affects the bits of data [0] to data [2]. Therefore, the bits of data [0] to data [2] become the clamp bits 650, and the bits corresponding to the clamp bits 650 among the data forming the substantial image included in the core pixel array 100 are changed to 0 or 1 en bloc by force. Because of this, the overall image data can be made even.

In another example, suppose the difference between the maximum value and the minimum value of the pixel data located in the optical black area is 20. Half of 20 is 10, and it is 1010 in binary digit. In this case, 4 bits correspond to the clamp bits, from the LSB, data [0], to data [3], as shown in FIG. 6. The values of data [0] to data [3] are transformed to a predetermined value of 0 or 1 en bloc. If the value is transformed to 1, the transformed data, from which the noise is removed, as shown in FIG. 8, is larger than the actually received pixel data by a range of less than half of the difference between the maximum value and the minimum value. Through this, the noise generated by the dark current is removed in advance, and it is inputted in the compensated data generating unit, which will be described later. And using the matching graph, it is transformed one more time to the compensated pixel data, which will be actually outputted. If the value is transformed to 0, the transformed data, from which the noise is removed, is smaller than the actually received pixel data by a range of less than half of the difference between the maximum value and the minimum value. Unlike FIG. 8, the transformed data, in the shape of staircase, will be formed below the curve of the actual pixel data.

Referring to FIG. 7, the upper graph shows the data that is not clamped by the digital clamping performing unit 356, and the lower graph shows the data clamped by the digital clamping performing unit 356. The upper graph shows the continuous oscillation of the upper and lower change of data, but the lower graph shows that the overall data is changing evenly.

FIG. 8 shows the enlarged views of section a and section b in FIG. 7. 810 shown in FIG. 8 is an enlarged view of section a in FIG. 7, and it shows that the pixel data has continuous oscillation due to the upper and lower change. However, 820 shown in FIG. 8 is an enlarged view of section b in FIG. 7, and it shows that the pixel data has a more flat shape because the values having the minute change at an interval of the clamp bits 650 after performing digital clamping transform to have the same value. The height of each staircase is the interval of the clamp bits 650. The staircase phenomenon in the image may be prevented by limiting the interval as described in the above.

Then in step S455, the compensated value for the black level is generated using the maximum value, the minimum value and the summation (or the normalized value).

FIG. 9 is a matching graph according to a preferred embodiment of the present invention. Referring to FIG. 9, it is preferable that the input signal has a one-to-one match with the output signal, like the ideal graph 210, if there is no black level. However, compensation is needed because the value of the image data of some part is raised by the dark current. With the conventional compensating graph 230, the normalized value of the pixel data included in the optical black area is calculated and is subtracted as the black level offset value 220. At this time, the overall brightness becomes low and the dynamic range of the output signal becomes small because the output signal becomes smaller than the input signal by the black level offset value 220.

In the present invention, the value of the output signal corresponding to the input signal of 0 to the normalized value, calculated in the step S445, becomes 0. And the matching graph 910 in a linear function is generated such that the value of the output signal is 0 and 1023 when the input signal is the normalized value 920 and 1023, respectively. The linear equation is shown below in Eq. 1:

$$ODV = \frac{1023}{1023 - NV} \times ( IDV - NV ) \qquad Eq . 1$$

Here, ODV is an output data value, IDV is an input data value, and NV is a normalized value. Because ODV is any one of the natural numbers between 0 and 1023, the digits below the decimal point can be predetermined to be rounded off, rounded up or rounded, when Eq. 1 is applied.

Through this process, the value of the output signal may be any one of the values between 0 and 1023. The overall brightness is not lost and the dynamic range is not reduced because this process is not done by subtraction. Therefore, the clear output image can be acquired.

Since 1023 is a number when the image data is a 10-bit data in Eq. 1, 1023 may be replaced by 2m-1 when the image data is an m (m is a natural number)-bit data.

Steps S435 and S450, among the steps shown in FIG. 4, may be omitted when only the black level compensation is needed, because the steps are needed when the noise by the dark current is to be removed.

While the above description has pointed out novel features of the invention as applied to various preferred embodiments, a skilled person will understand that various substitutions and changes in the form and details of the device or process illustrated may be made without departing from the scope of the invention.

### INDUSTRIAL APPLICABILITY

According to the present invention as described above, the image separation phenomenon by the dark current can be compensated.

Moreover, it is possible that the rendering range of the image data becomes wider and the image becomes clearer and sharper by the maximum use of dynamic range. And clearer images can be provided through the clamping of dark current noise.

What is claimed is

1. A method for compensating for a black level of an image sensor, the method comprising:
(a) initializing a frame and receiving a digital image signal;
(b) analyzing pixel information of a pixel included in the frame, wherein the digital image signal comprises the pixel information, and the pixel information comprises pixel data and area information of an area in which the pixel is located;
(c) generating a pixel data sum by summing the pixel data of the pixel located in an optical black area;
(d) determining a normalized value using the pixel data sum; and
(e) generating compensated pixel data by a predetermined equation using the normalized value, the compensated pixel data corresponding to the pixel data.

2. The method of claim 1, wherein:
the pixel data has n bits, n being a natural number, the value of the pixel data being between 0 and 2ⁿ-1; and
in case the dynamic range of the compensated pixel data has a value between 0 and 2ⁿ-1, the predetermined equation takes the pixel data for an independent variable and the compensated pixel data for a dependent variable, whereby the compensated pixel data is 2ⁿ-1 when the pixel data is 2ⁿ-1.

3. The method of claim 1, wherein the normalized value is obtained by dividing the pixel data sum with the total number of pixels included in the optical black area.

4. The method of claim 1, further comprising after the step (d) and before the step (e):
(d-1) converting each value of clamp bits among bits of the pixel data to a predetermined value of 0 or 1,
wherein, in case the pixel data is comprised of a bit stream of n (natural number) digits expressed in binary number, the clamp bits are a bit stream of sequential digits having a predetermined size comprising a least significant bit among the bits of n digits of the pixel data.

5. The method of claim 1, further comprising after the step (d) and before the step (e):
(d-1) determining a maximum value and a minimum value from the pixel data of the pixel included in the optical black area;
(d-2) setting bits corresponding to a difference between the maximum value and the minimum value as clamp bits among the bits of the pixel data; and
(d-3) converting each value of the clamp bits to a predetermined value of 0 or 1.

6. An apparatus for compensating for black level, the apparatus being connected between a sensor unit and an image data output unit of an image sensor, the apparatus comprising:
an optical black area detecting unit, the optical black area detecting unit detecting a pixel located in an optical black area, the pixel being in a digital image signal received from the sensor unit;
a pixel data analyzing unit, the pixel data analyzing unit summing pixel data of the pixel detected by the optical black area detecting unit to a pixel data sum; and
a compensated data generating unit, the compensated data generating unit generating compensated pixel data corresponding to the pixel data by a predetermined equation using a normalized value,
wherein the normalized value is obtained by dividing the pixel data sum with the total number of pixels included in the optical black area.

7. The apparatus of claim 6, wherein:
the pixel data has n bits, n being a natural number, the value of the pixel data being between 0 and 2ⁿ-1; and
in case the dynamic range of the compensated pixel data has a value between 0 and 2ⁿ-1, the predetermined equation takes the pixel data for an independent variable and the compensated pixel data for a dependent variable, whereby the compensated pixel data is 2ⁿ-1 when the pixel data is 2ⁿ-1.

8. The apparatus of claim 6 further comprising a digital clamping performing unit, converting each value of clamp bits among bits of the pixel data to a predetermined value of 0 or 1,
wherein, in case the pixel data is comprised of a bit stream of n (natural number) digits expressed in binary number, the clamp bits are a bit stream of sequential digits having a predetermined size comprising a least significant bit among the bits of n digits of the pixel data.

9. The apparatus of claim 6 further comprising a digital clamping performing unit, converting each value of clamp bits among the bits of the pixel data to a predetermined value of 0 or 1,
wherein the clamp bits correspond to a difference between a maximum value and a minimum value of the pixel data of the pixel included in the optical black area.

10. A method for compensating for a black level of an image sensor, the method comprising:
(a) initializing a frame and receiving a digital image signal;
(b) analyzing pixel information of a pixel included in the frame, wherein the digital image signal comprises the pixel information, and the pixel information comprises pixel data and area information of an area in which the pixel is located;
(c) generating a pixel data sum by summing the pixel data of the pixel located in an optical black area;
(d) determining a normalized value using the pixel data sum;
(e) determining non-constant offset value using the normalized value; and
(f) compensating the black level using the non-constant offset value with respect to the frame,
wherein the value of the uncompensated input digital image signal and the value of its corresponding compensated output signal have linear relationship.

11. The method of claim 10, wherein the linear relationship can be determined by employing a predetermined equation.

12. An apparatus for compensating for black level, the apparatus comprising:
means for detecting a pixel located in an optical black area, the pixel being in a digital image signal received from the sensor unit;
means for summing pixel data of the pixel detected by the optical black area detecting unit to a pixel data sum; and
means for generating compensated pixel data corresponding to the pixel data by a predetermined equation using a normalized value,
wherein the normalized value is obtained by dividing the pixel data sum with the total number of pixels included in the optical black area.

13. The apparatus of claim 12 further comprising means for converting each value of clamp bits among bits of the pixel data to a predetermined value of 0 or 1,
wherein, in case the pixel data is comprised of a bit stream of n (natural number) digits expressed in binary number, the clamp bits are a bit stream of sequential digits having a predetermined size comprising a least significant bit among the bits of n digits of the pixel data.

14. The apparatus of claim 12 further comprising means for converting each value of clamp bits among the bits of the pixel data to a predetermined value of 0 or 1,
wherein the clamp bits correspond to a difference between a maximum value and a minimum value of the pixel data of the pixel included in the optical black area.
